(19) United States
(12) Patent Application Publication
(10) Pub. No.: US 2014/0040913 A1
(43) Pub. Date: Feb. 6, 2014

(54) JOB PLAN VERIFICATION

(71) Applicants: Andreas Wuttke, Sindelfingen Baden Wurttemberg (DE); Subramaniam Venkata Kalambur, Bangalore (IN); Albrecht Schroth, Herrenberg (DE)

(72) Inventors: Andreas Wuttke, Sindelfingen Baden Wurttemberg (DE); Subramaniam Venkata Kalambur, Bangalore (IN); Albrecht Schroth, Herrenberg (DE)

(21) Appl. No.: 14/110,406

(22) PCT Filed: Jul. 26, 2011
(86) PCT No.: PCT/US2011/045383

§ 371 Date: Oct. 7, 2013

(51) Int. Cl. G06F 9/50

(52) U.S. Cl. CPC G06F 9/50
USPC 718/104

(57) ABSTRACT

A job plan verification system (100) may include a job analysis module (104) to receive job details for jobs to be executed, and a job history management module (105) to receive prior job execution data. A facts creator module (107) may generate planned execution object instances for the jobs to be executed based on the job details and the prior job execution data. A verification module (108) may generate a verification report (110) for the jobs to be executed based on rules for job management and the planned execution object instances.

### BACKGROUND

For information management (IM) applications such as data protection, one major administrative task is to maintain schedules for jobs that have to be executed on a regular base. In large enterprise or cloud environments, it can become difficult for administrators to ensure that the scheduled jobs will be processed as expected and that there are no conflicts with resources that are allocated.

Generally, within large enterprise or cloud environments, thousands of jobs may have to be scheduled. These jobs may utilize multiple resources during their execution, including, for example, devices, network bandwidth, resources on the management server etc. Moreover, job schedules may be created and modified by multiple users in parallel. Due to such factors, it can become challenging to define new job schedules that do not cause resource conflicts with existing job schedules. As a result, more and more jobs are either delayed or even fail at the planned execution time due to lack of resources needed for their execution. Thus job execution can become unpredictable and defined service level objectives may be violated. Furthermore, optimal utilization of an expensive hardware infrastructure cannot be ensured since no hint is given to the user about expected resource usage and how it may be improved. Moreover, the effect of temporary resource shortages (e.g. due to device or network failures) cannot be determined unless related jobs are actually affected during runtime. In addition, known job schedule solutions cannot simulate beforehand the effect of planned changes to the environment. The result is thus seen as soon as the changes are actually applied.

For example, a company's IT infrastructure may have thousands of server systems that have to be backed up using thousands of backup devices. The complexity of manually scheduling backup jobs within this environment can be very inefficient. The scheduling may be performed on a trial and error basis, which can take an extensive amount of time and effort.

As discussed above, in today's environment, resource conflicts are generally discovered at job execution time. One way of dealing with these conflicts is to either queue up jobs until all needed resources become available or to cancel jobs in case resources do not become available within a predetermined time period. For example, if jobs process adequately, a user may conclude that the job scheduling was appropriate. However, if there is a conflict, job execution may have to be modified at job execution time to modify, for example, timing or resource allocation. Either of these options can cause delay in job processing. Device utilization reports may be generated based on history data, but this also does not help in case existing job schedules have to be changed or new jobs have to be added.

### BRIEF DESCRIPTION OF DRAWINGS

The embodiments are described in detail in the following description with reference to the following figures.

FIG. 1 illustrates a job plan verification system, according to an embodiment;

FIG. 2 illustrates job plan schedules for the job plan verification system, according to an embodiment;

FIG. 3 illustrates rule flow for the job plan verification system, according to an embodiment;

FIG. 4 illustrates rule checking for device conflicts, according to an embodiment;

FIG. 5 illustrates segmentation of the planning scope for the job plan verification system, according to an embodiment;

FIG. 6 illustrates an example of a prototype setup for the job plan verification system, according to an embodiment;

FIG. 7 illustrates a sample output of the job plan verification system, according to an embodiment;

FIG. 8 illustrates a method for job plan verification, according to an embodiment; and

FIG. 9 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

### 1. Overview

A job plan verification system is described herein and provides a user with the ability to verify a job roster in a very flexible and automated manner before jobs are actually executed. The system provides verification of job schedules for a defined planning scope using a flexible rule-based approach. As a result, the service quality is improved while the labor time and effort for the job plan maintenance is minimized.

As described in greater detail below, the job plan verification system may generally receive data from an IM system that performs job scheduling and job execution. The IM system may include an IM application that includes job details such as assigned resources and defined schedules. The IM system may also include IM data about prior job executions. The job plan verification system may include a job analysis module to collect job details such as assigned resources and defined schedules from the IM application. A job history management module may collect data about prior job executions from the session history of the IM application, which feeds into the IM data. Based on this historical data, the estimated job duration may be calculated. An environment data module may collect environment specific data related to, for example, network topology, server capacity, and capacities of connections used by the job resources (e.g. devices). Job data, which includes the schedule information collected by the job analysis module and the job history management module, and environment data may be used by a facts creator module to generate planned execution object instances within a defined planning scope. Alternatively, the facts creator module may use just the job data to generate planned execution object instances within the defined planning scope. Each planned execution object instance may represent one execution of a job within the planning scope having a defined starting date, time and duration. The generated planned execution object instances and the job details collected by the job analysis module may be asserted into a rule-based verification module. The verification module may be executed to generate a verification report that provides details about the different jobs, possible conflicts and resource utilization.

The job plan verification system provides for detection of job resource conflicts before they actually happen. In other words, the job plan verification system simulates and models future job executions and possible conflicts within a defined planning scope. The rule-based verification of job plan schedules offers a flexible mechanism to automatically check existing job schedules for resource conflicts within a defined future time period. New constraints may be readily added by defining additional rules. This automated job schedule verification gives the user the opportunity to prevent possible resource conflicts proactively before they actually happen during job execution.

As discussed above, the job plan verification system may also be used to simulate what-if scenarios. For example, the positive effect of adding a new device on an anticipated future resource conflict may be simulated. The failure of one or more resources may also be simulated. Furthermore, the addition of new jobs may be simulated in order to ensure that no resource conflicts are generated. Certain time periods (e.g. year end processing) may be verified a long time ahead. For example, the job plan verification system may be used to determine which jobs would be affected by a failure, for example, within the next 24 hours or at another time period. Reports such as the expected device allocation, server load or network utilization may be readily generated for a specified future time period using the same, rule-based approach. The job plan verification system thus provides flexibility by the rule language to check for resource conflicts, certain priority conditions and to create reports on future job executions. These aspects also facilitate adaptation to new applications or extension with new rules by providing a new set of rules. A user may react on expected issues at a convenient time before job processing, rather than out of necessity based on job processing conflicts with existing jobs.

### 2. System

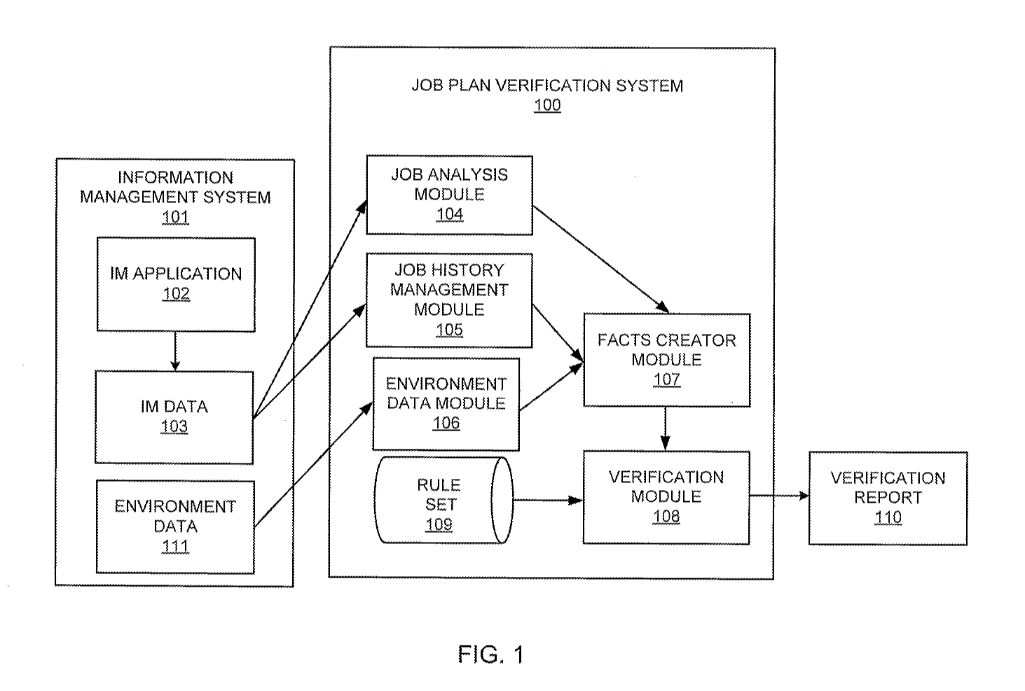

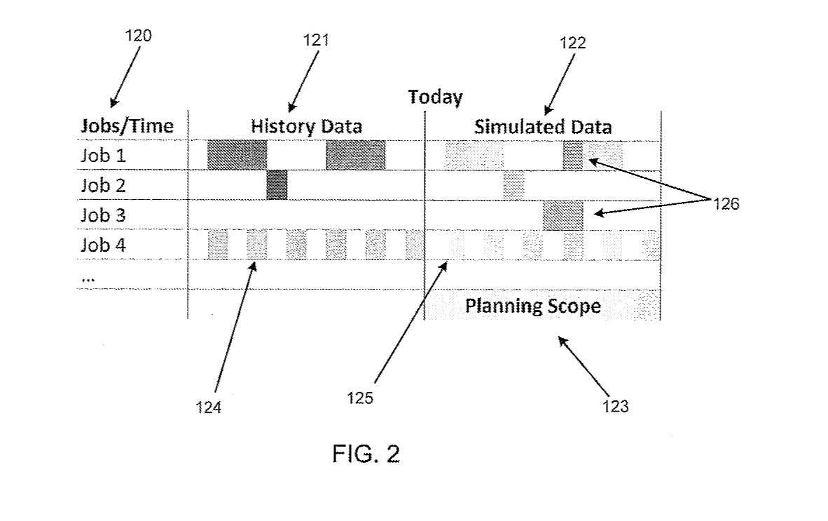

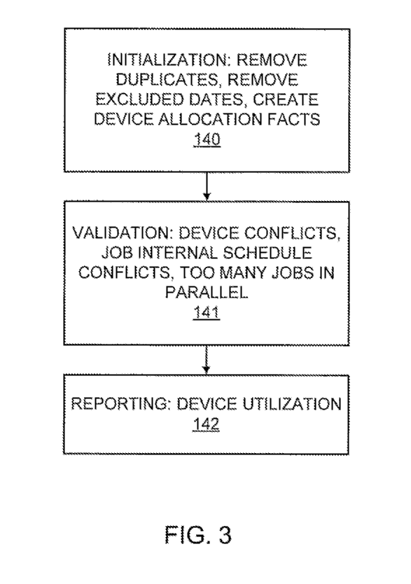

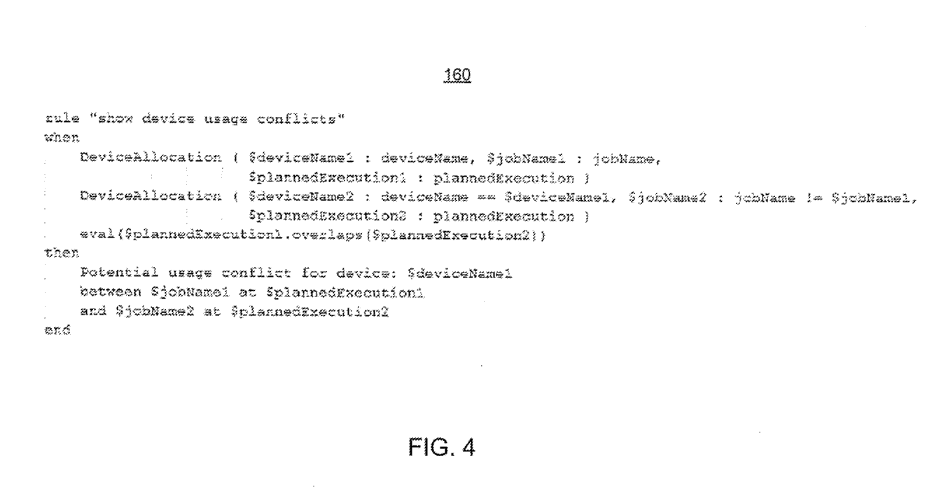

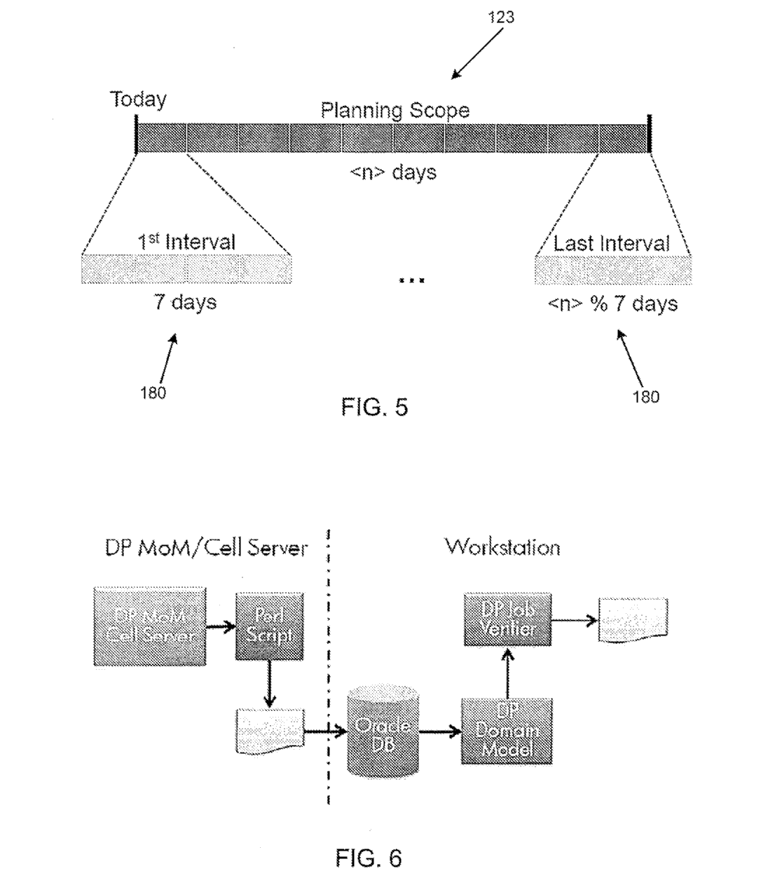

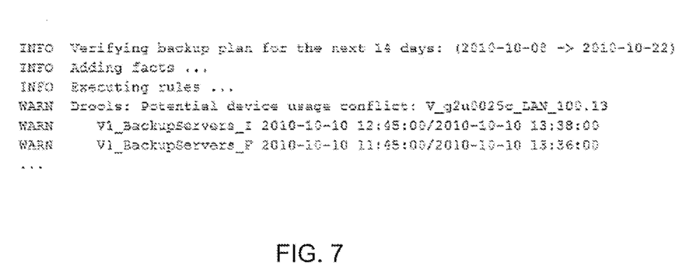

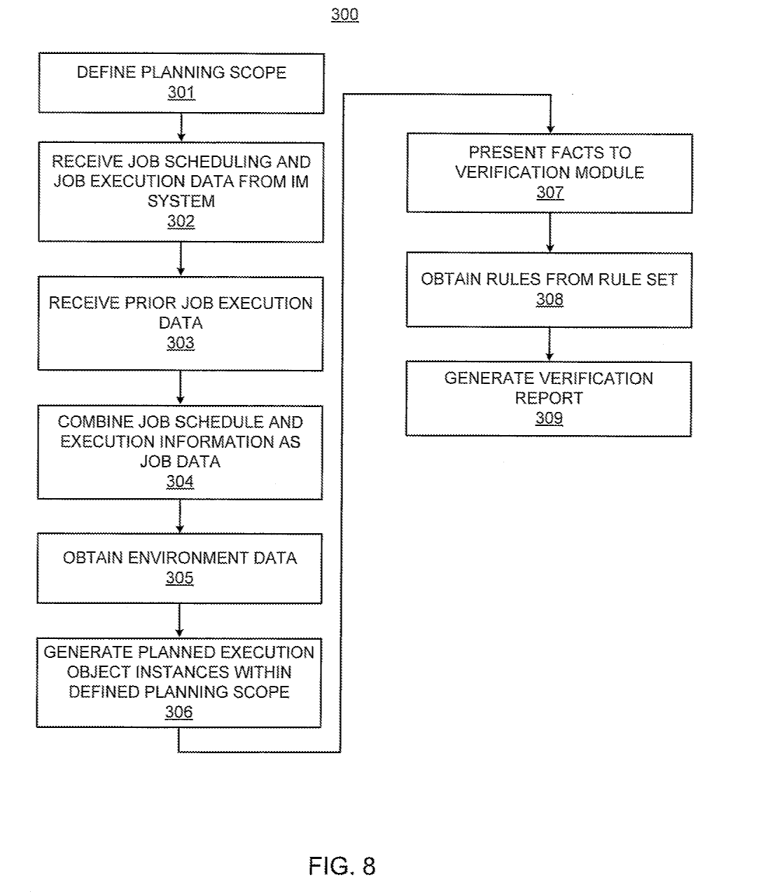

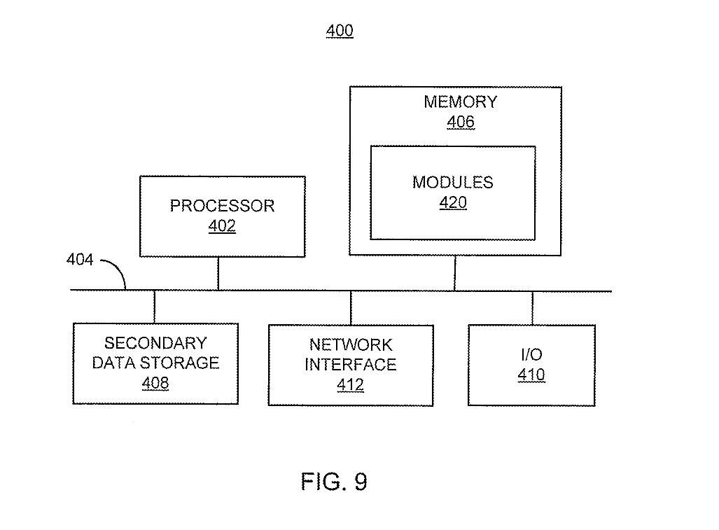

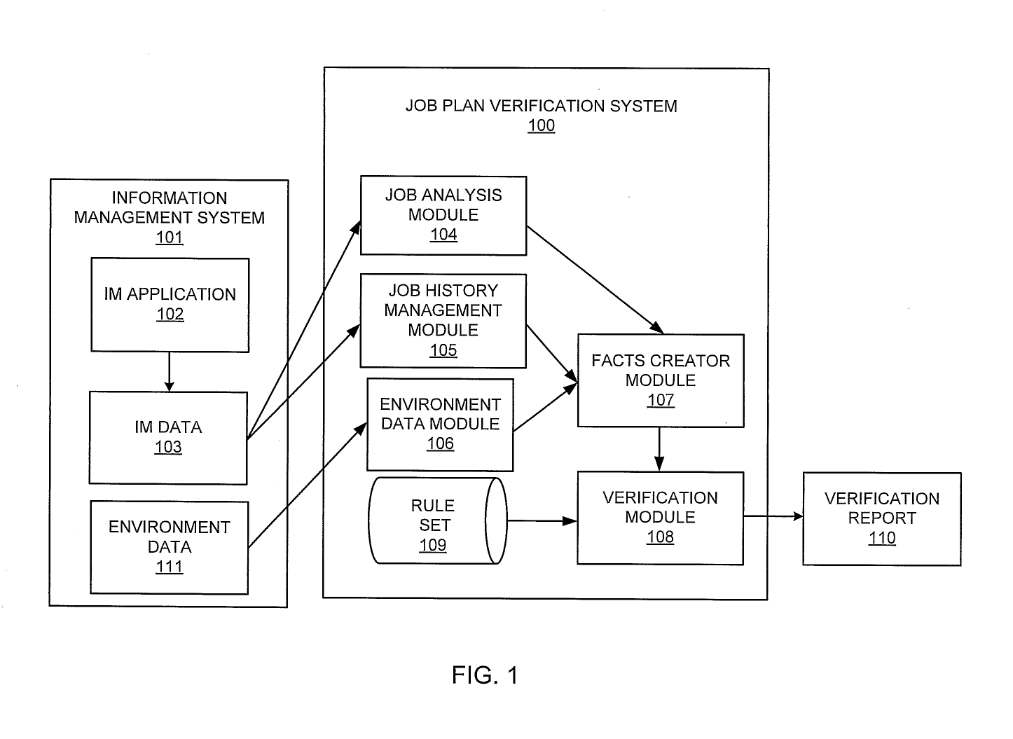

FIG. 1 illustrates a job plan verification system 100, according to an embodiment. The system 100 may generally receive data from an IM system 101 that performs job scheduling and job execution. The IM system may include IM application 102 that includes job details such as assigned resources and defined schedules. Jobs may include, for example, data archiving. The IM application 102 may thus keep data on jobs that have been scheduled. The IM system may also include IM data 103 about prior job executions (i.e. execution histories of jobs). The job plan verification system 100 may include a job analysis module 104 to collect job details such as assigned resources and defined schedules from the IM application 102. The modules and other components of the system 100 may include machine readable instructions, hardware or a combination of machine readable instructions and hardware. For example, the job analysis module 104 may extract the names of jobs, including, for example, the resources that are used by the jobs. The job analysis module 104 may also extract information on the devices for performing the job (i.e. for backing up data with devices such as tapes, disks etc.). A job history management module 105 may collect data about prior job executions from the session history of the IM application 102 which may be fed into the IM data 103. Based on this historical data, the estimated (i.e. expected) job duration may be calculated. The schedule information collected by the job analysis module and the job history management module may then be combined as job data, or alternatively, may be directly fed to a facts creator module 107 as described below. An environment data module 106 may collect environment data 111 related to, for example, the network topology, server capacity, and capacities of the connections used by the job resources (e.g. devices). The job data and environment data 111 may be used by the facts creator module 107 to generate planned execution object instances within a defined planning scope, described in further detail below. Alternatively, the facts creator module 107 may use just the job data to generate planned execution object instances within the defined planning scope. The job data may describe the jobs including their schedules, expected duration, and resources that are being utilized. Based on the job data and the environment data 111, facts may be generated by the facts creator module 107. Facts may be in the form of object instances which represent the different jobs and the representations may be presented to a verification module 108. Each planned execution object instance may represent one execution of a job within the planning scope having a defined starting date and time and duration. The generated planned execution object instances and the job details collected by the job analysis module may be asserted into the rule-based verification module 108. The verification module 108 may obtain rules for job management from the rule set 109. The rule set 109 may be divided into different groups for conflict management and resource utilization analysis of jobs as described below. Upon execution, the verification module 108 may generate a verification report 110 that provides details about the different jobs, possible conflicts and resource utilization.

Referring to FIG. 1, using the system 100, the job verification process may begin by defining a planning scope. This planning scope may begin at the current date or at any future date, and end <n> days later. To begin, the job analysis module 104 may collect job details, such as assigned resources and defined schedules from the IM data 103. The job history management module may then collect data about prior job executions from the session history of the IM application 102 that may be fed into the IM data 103. Based on this historical data, the estimated job duration may be calculated (e.g. using the average duration plus a buffer).

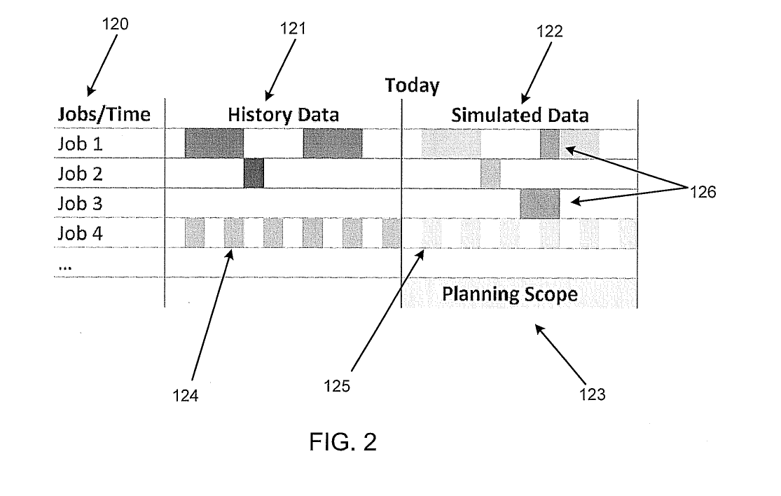

FIG. 2 illustrates how planned executions instances may be generated for each job. For example, referring to FIG. 2, the estimated job duration is calculated for Jobs 1, 2 and 4, with the jobs being collectively designated 120. In FIG. 2, history data, simulated data and the planning scope are respectively designated 121, 122 and 123. The shaded boxes in FIG. 2 generally represent job executions that either actually happened in the past or are planned in the future. For example, Job 1 includes two job executions, Job 2 includes 1 job execution etc. The repetition of the shaded boxes in FIG. 2 also represents the recurrence of a job within the planning scope 123. For example, Job 1 recurs twice, whereas Jobs 2 and 3 occur once within the planning scope 123. It should be noted that the history data 121 may differ from planned job execution objects generated based on the current job schedule and job duration taken from the history data. For example, a schedule which was valid for the history data may not be relevant for generation of the simulated data 122. The currently defined schedule from the IM system 101 may be used to generate the planned execution objects in the planning scope. Thus the interval of historic job executions may look different than the intervals valid in the planning scope. In the example provided, it is assumed that the job schedules were not changed. Therefore the history data 121 and the simulated data 122 show the same intervals. The simulation aspect of the system 100 as described herein may be used for jobs that recur in the future. The shaded areas 124 under history data show times at which the history data 121 is available. The job timings for new jobs are shown as shaded areas 125 (also designated planned execution objected instances) under the simulated data 122. Possible conflicts in schedule are shown at 126, for example, for Jobs 1 and 3. For the possible conflicts for Jobs 1 and 3, a user may address the conflicts by modifying the schedule or allocating additional resources. Additionally, the verification report 110 generated by the system 100 may propose similar methods (e.g. general schedule and resource changes) and provide related specifics (e.g. proposed timing changes, resources needed) for addressing conflicts. If no job history data is available (e.g. for new jobs), a heuristic may be used in order to estimate the duration of the job. For example, for Job 3, since no historic data is available, a heuristic may be used for estimating the job duration. For example, by determining the amount of data needed to be backed up, the type of devices being used etc., based on such factors, the time needed for the backup can be estimated to thus estimate job duration. The schedule information collected by the job analysis module 104 and the job history management module 105 may then be used by the facts creator module 107 to generate the planned execution object instances 125 within the defined planning scope. Each planned execution object instance may represent one execution of a job within the planning scope having a defined starting date, time and duration.

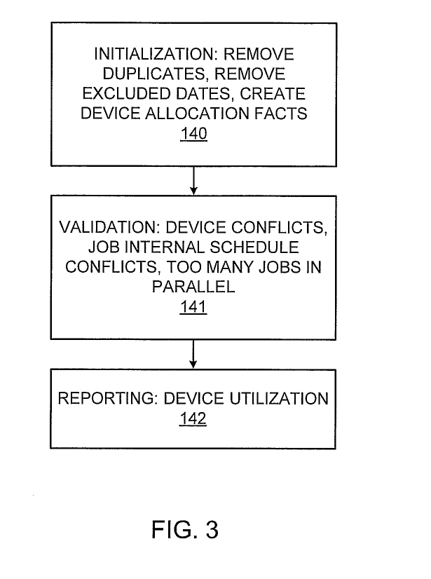

The generated planned execution object instances and the job details collected by the job analysis module 104 may then be asserted into the rule-based verification module 108. The facts creator module 107 may then create additional helper objects. Helper object instances may provide additional information to the rule system that is not included in the planned execution objects themselves or are derived from them. Thus the helper object instances may be related to the planned execution object instances and may be used by the rules to perform validations. The facts creator module 107 may create plan exclusion object instances (e.g. days excluded from the job schedule) based, for example, on the job schedule definition provided by the job analysis module 104. Environment specific object instances (e.g. server capabilities) may be created based on the data provided by the environment data module 106. Thereafter, the verification module 108 may then execute different types of rules from rule set 109 according to the rule flow illustrated in FIG. 3. Referring to FIG. 3, the rule set 109 may include three groups of rules defined, namely, initialization rules 140, validation rules 141 and reporting rules 142. The rules within each group may have different priorities in order to control their execution sequence. The initialization rules 140 may prepare the fact base for the validation and reporting phase. Initialization rules may also be used to generate helper object instances that make it easier to check for specific conditions. An initialization rule may be used to generate device allocation objects that show at which time period a specific device is allocated to a job. The device allocation object instances may contain the device name, and may be used by a rule to verify specific conditions (i.e. in the conditional part of the rule). The initialization rules may also be used to clean up the data (e.g. duplicates can be removed, where depending on the scheduling mechanism certain jobs may be listed multiple times). Functionality may be implemented from the information management application. Further, excluded job executions may be removed. For example, assuming a schedule occurs every Friday at a certain time, but it is explicitly stated that a job cannot happen on a specific date, such constraints can be extracted from the job definitions so that the job analysis module 104 may create exclusion facts which are then used by the initialization phase to remove these job executions from the verification module 108 so that they are not considered anymore.

The validation rules 141 may perform the actual verification of the job schedules against constraints. Validation rules may check for all types of potential resource conflicts, as long as the data is made available to the rule system. For example, the validation rules 141 may check for device conflicts, job internal schedule conflicts, and if there are too many jobs active on one server in parallel. The validation rules 141 may also check for device allocations that are acceptable, or if jobs are within a certain backup window, for example, to make sure that certain backups happen during a certain time window (e.g. between 8 pm and 8 am on weekdays).

The reporting rules 142 may be used to generate reports based on the facts available. For example, based on the device allocation object instances generated by an initialization rule, a reporting rule may calculate the estimated device utilization within the defined planning scope. Using this data, a free device slots report may be generated, helping administrators schedule new jobs accordingly. For example, the reporting rules 142 may create device allocation statistic, for example, stating that a device is utilized a certain percentage within a planning scope. This may also facilitate determination of which devices are used at capacity and which are not used at all to allow the unused devices to be used for future jobs.

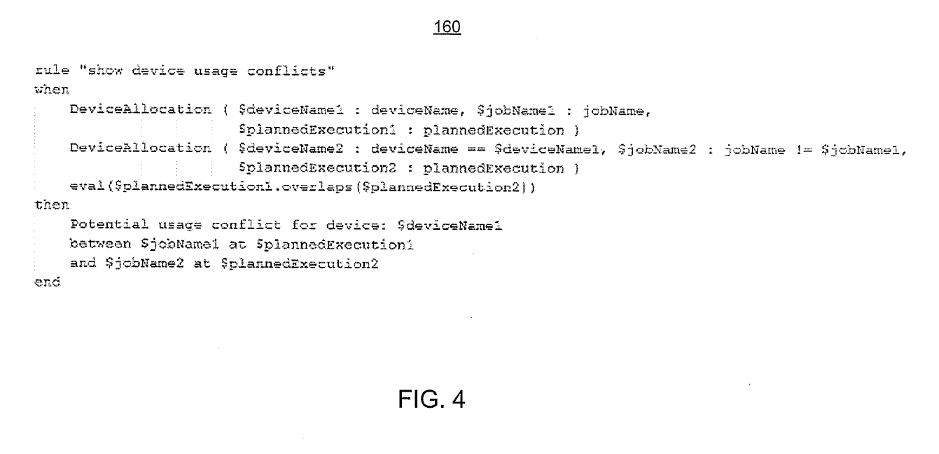

Referring to FIG. 4, the conflict between Jobs 1 and 3 may be determined by a rule 160 as illustrated. The rule 160 may check for device allocation objects that have the same device name, different job names and finally, overlapping planned execution intervals.

The rule-based definition of resource conflicts and other conditions provides several options. For example, the application data model may be available in a JAVA object structure using, for example, standard getter and setter methods. These data objects may be asserted as facts to the system 100 before the rules are executed, for example, if the rule system would have access to network connectivity data it could verify if certain jobs running in parallel on devices attached to the same network connection would generate a potential resource issue on the corresponding network connection. Even cross-application resource conflicts may become detectable if job schedule data would be shared with the system 100. For example, a source for such data may include HEWLETT PACKARD'S Universal Configuration Management Database software (UCMDB). The CMDB software may automatically maintain accurate, up-to-date information on the relationships between infrastructure, applications, and business services.

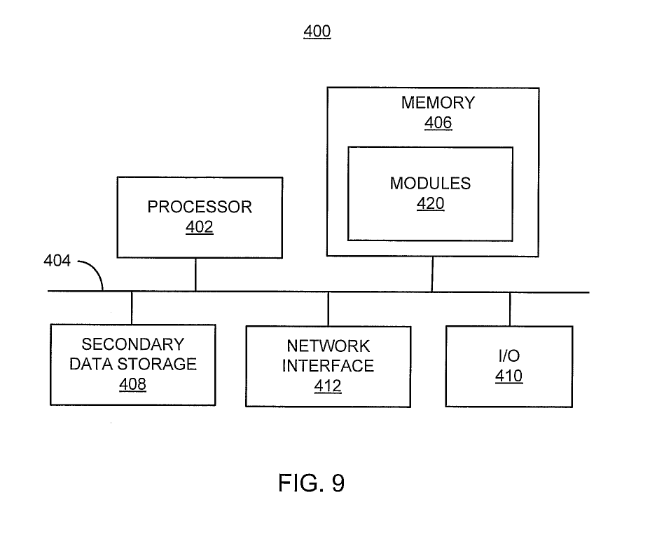

Depending on the length of the planning scope, the number of jobs and the schedule intervals, several planned execution objects may be generated, occupying a large amount of memory 406 (see FIG. 9). A large verification job may be partitioned into smaller jobs, for example, for cloud based processing. For example, a job may be partitioned based on time. Therefore, in order to limit resource consumption, larger planning scopes may be partitioned into smaller planning scopes which are verified consecutively or in parallel. For jobs that cross scope boundaries, all affected scopes of such jobs may be considered. For example, a planned execution abject instance starting in Interval 1 and ending in Interval 2 may have to be evaluated within both intervals.

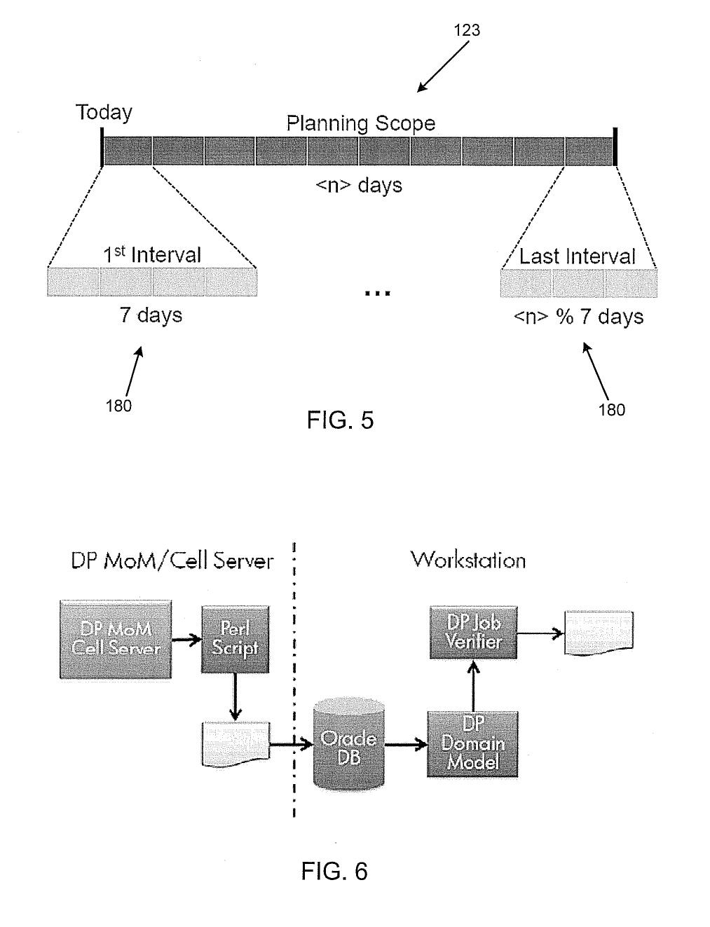

FIG. 5 shows how the planning interval (i.e. planning scope) 123 may be segmented into 7 day intervals at 180. This approach provides for scalability and for cloud based processing. The rule-based operation of the system 100 provides for efficient checking of the current configuration of an environment.

In addition to the verification of already scheduled jobs, the system 100 may also be used to simulate the effect of modifications to existing job schedules or additions of new job schedules to the environment. This may also include the simulation of resource outages. For example, in case of a device failure, a report may be generated showing all planned job executions within the next 24 hours that will be affected. The planning scope may also be implemented as a kind of moving window having a starting date defined somewhere in the future. For example, if combined with a user interface utilizing, for example. GANTT CHARTS to visualize the job roster, a user may verify specific time periods in the future, for example when the year-end processing is done and therefore resource conflicts are more likely.

With regard to the foregoing rule based approach, the approach may be extended to additional resources. For example, constraints may be placed on application servers to limit the number of jobs that can be handled in parallel (e.g. 10 jobs in parallel). In this regard, a user can be preemptively warned if greater than a predetermined number of jobs (e.g. greater than 10 jobs) would be running in parallel.

An example of an implementation of the system 100 with HEWLETT PACKARD'S Data Protector is shown in FIG. 6.

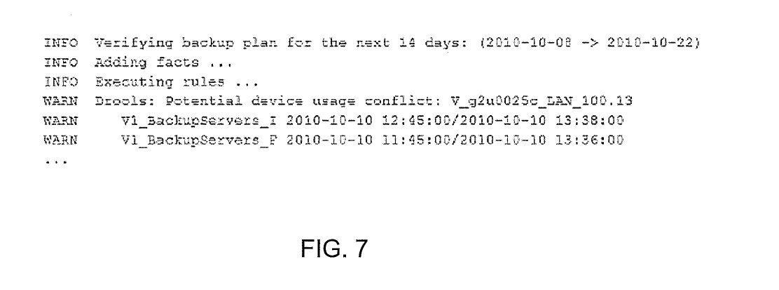

Referring to FIG. 6, the implementation may include a PERL script and a JAVA application. The PERL script may extract all necessary job and schedule information from the HEWLETT PACKARD Data Protector DB and from backup and schedule configuration files. This data may then be stored into an ORACLE DB using a data schema. The JAVA application may be the job plan verification system 100. The JAVA application may take the job data object instances from the ORACLE DB using, for example, HIBERNATE, determine the estimated job durations, and generate the planned execution objects as described above. Then all the data objects may be asserted as facts into, for example, the DROOLS EXPERT rule-based system. After all the planned execution and job data is asserted into the working memory of DROOLS EXPERT, a set of rules may be executed on the planned execution data. Different sets of rules may be used for initialization, verification, reporting and debugging. In a first step, an initialization rule may generate device allocation object instances. After that, the verification rules may be executed, generating a report showing potential resource conflicts within the current configuration. FIG. 7 shows a sample output of the implementation example of the system 100. FIG. 7 shows a conflict with the device V_g2u0025c_LAN_{—}100.13, which would be needed by the jobs V1_BackupServers_I and V1_BackupServers_F at the same time. As another result of the job verification, a XML report may be created. This report may be converted into other formats (e.g. html) using, for example, XSL transformations. The rule set may be loaded by the DROOLS EXPERT rule engine from a text file during startup and may be extended or updated as needed.

### 3. Method

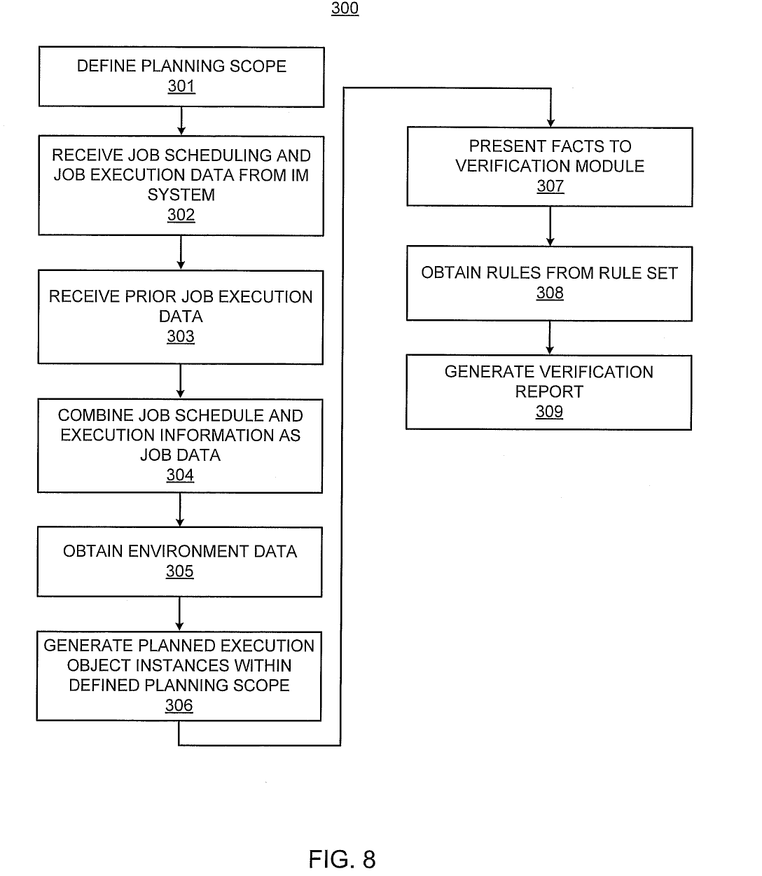

FIG. 8 illustrates a method 300 for job plan verification, according to an embodiment. The method 300 is described with respect to the job plan verification system 100 shown in FIG. 1 by way of example and not limitation. The method 300 may be performed by other systems.

At block 301, using the system 100, the job verification process may begin by defining a planning scope. This planning scope may begin at the current date or at any future date and end <n> days later. In an example, the verification may be performed just for all planned job executions within this defined planning scope, and all planned job executions outside of the planning scope may be ignored.

At block 302, the system 100 may receive data from the IM system 101 that performs job scheduling and job execution. Referring to FIG. 1, the IM system may include the IM application 102 that includes job details such as assigned resources and defined schedules. The IM application 102 may thus keep data on jobs that have been scheduled. The IM system may also include the IM data 103 about prior job executions (i.e. execution histories of jobs). The job analysis module 104 may collect job details such as assigned resources and defined schedules from the IM application 102. For example, the job analysis module 104 may extract the names of jobs, including, for example, the resources that are used by the jobs. The job analysis module 104 may also extract information on the devices for performing the job (i.e. for backing up data with devices such as tapes, disks etc.).

At block 303, the job history management module 105 may receive data about prior job executions from the session history of the IM application 102 which may be fed into the IM data. Based on this historical data, the estimated (i.e. expected) job duration may be calculated.

At block 304, the schedule information collected by the job analysis module and the job history management module may then be combined as job data.

At block 305, the environment data 111 from the environment data module 106 may be obtained and asserted into working memory. For example, the working memory may be the memory 406 (see FIG. 9) area used by the verification module 108. All facts may be asserted into the working memory such that the facts are made visible to the verification module 108. The environment data may include data related to, for example, the network topology, server capacity, and capacities of the connections used by the job resources (e.g. devices).

At block 306, information from the job data may be used by the facts creator module 107 to generate planned execution object instances within a defined planning scope. Alternatively, information from the job data and the environment data may be used by the facts creator module 107 to generate planned execution object instances within the defined planning scope. The job data may describe the jobs including their schedules, expected duration, and resources that are being utilized. Based on this data, facts may be generated by the facts creator module 107.

At block 307, facts in the form of object instances which represent the different jobs and the representations may be presented to the verification module 108. Each planned execution object instance may represent one execution of a job within the planning scope having a defined starting date and time and duration. The generated planned execution object instances and the job details collected by the job analysis module may be asserted into the rule-based verification module 108.

At block 308, the verification module 108 may obtain rules from the rule set 109. The rule set 109 may be divided into different groups as described above. For example, referring to FIG. 3, the rule set 109 may include three groups of rules defined, namely, initialization rules 140, validation rules 141 and reporting rules 142.

At block 309, upon execution, the verification module 108 may generate a verification report 110 that provides details about the different jobs, possible conflicts and resource utilization.

### 4. Computer Readable Medium

FIG. 9 shows a computer system 400 that may be used with the embodiments described herein. The computer system 400 represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums. The memory 406 may include modules 420 including machine readable instructions residing in the memory 406 during runtime and executed by the processor 402. The modules 420 may include the modules 104-108 of the system 100 shown in FIG. 1.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

What is claimed is:

1. A job plan verification system comprising:
a job analysis module (104) to receive job details for jobs to be executed;
a job history management module (105) to receive prior job execution data;
a facts creator module (107) to generate planned execution object instances for the jobs to be executed based on the job details and the prior job execution data; and
a verification module (108), executed by a processor, to generate a verification report (110) for the jobs to be executed based on rules for job management and the planned execution object instances.

2. The system of claim 1, further comprising an environment data module to collect environment data related to server capacity and network topology for the jobs to be executed, wherein the facts creator module generates planned execution object instances for the jobs to be executed based on the job details, the prior job execution data, and the environment data.

3. The system of claim 1, wherein the job details include details related to assigned resources, defined schedules and durations for the jobs to be executed.

4. The system of claim 1, wherein the planned execution object instances represent executions of the jobs to be executed within a defined planning scope.

5. The system of claim 1, wherein the planned execution object instances are generated for a defined planning scope having a future starting date.

6. The system of claim 5, wherein the planning scope is partitioned into multiple planning scopes which are analyzed consecutively or in parallel.

7. The system of claim 1, wherein the rules include initialization rules for at least one of removing duplicates, removing excluded dates and creating device allocation facts.

8. The system of claim 1, wherein the rules include validation rules for at least one of assessing device conflicts, job internal schedule conflicts and parallel jobs.

9. The system of claim 1, wherein the rules include reporting rules for reporting device utilization.

10. The system of claim 1, wherein the verification report provides details about possible conflicts and resource utilization.

11. The system of claim 1, wherein the verification report provides recommendations for addressing possible conflicts and resource utilization.

12. The system of claim 1, wherein the facts creator module further generates helper object instances for the jobs to be executed based on the job details and the prior job execution data, and wherein the helper object instances include at least one of plan exclusions and server capabilities.

13. A method for job plan verification, the method comprising:
receiving job details for jobs to be executed (302);
receiving prior job execution data (303);
receiving environment data (305);
generating planned execution object instances (306) for the jobs to be executed based on the job details, the prior job execution data and the environment data; and
generating, by a processor, a verification report (309) for the jobs to be executed based on rules for job management and the planned execution object instances.

14. The method of claim 13, wherein the rules include validation rules for at least one of assessing device conflicts, job internal schedule conflicts and parallel jobs.

15. A non-transitory computer readable medium storing machine readable instructions, that when executed by a computer system, perform a method for job plan verification, the method comprising:
receiving job details for jobs to be executed (302);
receiving prior job execution data (303);
receiving environment data (305);
generating planned execution object instances (306) for the jobs to be executed based on the job details, the prior job execution data and the environment data; and
generating, by a processor, a verification report (309) for the jobs to be executed based on rules for job management and the planned execution object instances.
